(19) United States
(12) Patent Application Publication
(10) Pub. No.: US 2002/0093946 A1
(43) Pub. Date: Jul. 18, 2002

(54) Integrated monolithic electronic component for connection on an internet network

(76) Inventor: Stephane Schinazi, Merignac (FR)

Correspondence Address: T. Daniel Christenbury, Schnader Harrison Segal & Lewis LLP, Suite 3600, 1600 Market Street, Philadelphia, PA, 19103, US

(21) Appl. No.: 10/005,706

(22) Filed: Nov. 12, 2001

Related U.S. Application Data
(63) Continuation of application No. PCT/FR01/00781, filed on Mar. 15, 2001.

(30) Foreign Application Priority Data
Mar. 15, 2000 (FR) FR 00/03322

(51) Int. Cl. H04L 12/28

(52) U.S. Cl. 370/352; 370/351; 370/465

(57) ABSTRACT

The invention concerns an integrated monolithic electronic component for connection to a telecommunications network and data exchange in accordance with a part at least of the Internet protocols, characterized in that said component includes an architecture of the DSP (Digital Signal Processor) type.

### RELATED APPLICATION

This is a continuation of International Application No. PCT/FR01/00781, with an international filing date of Mar. 15, 2001, which is based on French Patent Application No. 00/03322, filed Mar. 15, 2000.

### FIELD OF THE INVENTION

This invention relates to the field of telecommunications and, more particularly, systems allowing a piece of equipment to be fitted with an Internet network access function.

### BACKGROUND

It is known to use microprocessors or ASIC connected to random-access memories in which is loaded network protocol software used by the Internet, associated with systems allowing the physical interface to be formed with a telecommunications network, such as a cable modem, a modem radio or an Ethernet card. These are high cost components, which means that an Internet network access function cannot be achieved at low cost.

Also known are communication terminals comprising processors of the DSP (Digital Signal Processor) family intended for full digital processing of a telecommunications signal in which a modem application program is loaded to provide an interface between digital signals and numeric signals. These components are generally made using CMOS technology, and incorporate internal memories the size of which is known by those skilled in the art as being insufficient for other programs to be loaded. In this event, it is necessary to add additional components to process Internet protocols.

Also known is WO98/37665 which concerns an Internet switch unit serving as a connection between a telephone set and a public switched telephone network (PSTN) line. The latter is used both for telephone conversations on the PSTN and to serve as a connection with an Internet Service Provider (ISP). The switch unit contains hardware and incorporated software, making it possible to establish a connection with an ISP and a telephony device via the Internet.

When two users, each having an Internet switch unit connected to the telephone set, want to have a telephone conversation via the Internet, one of the users calls the other via the PSTN. When they agree upon a telephone conversation via the Internet, they send a signal to their Internet switch unit either by pressing buttons located on the switch unit or by pressing the buttons of the telephone keypad to obtain a switch to the Internet telephony system. The switch units disconnect the PSTN call and connect to their ISP. Once the switch units are connected to the Internet, they communicate with each other via a server, which provides the Internet Protocol (IP) addresses of the switch units, and the users can continue their conversation via the Internet telephony device.

### SUMMARY OF THE INVENTION

The invention overcomes these drawbacks by using a single monolithic component, which, surprisingly, allows all Internet network access functions to be performed.

The invention relates to an electronic component for connection to a telecommunications network and data exchange in accordance with at least a part of Internet protocols including an integrated monolithic component constituted by a DSP (Digital Signal Processor) architecture including at least one memory in which is loaded a program implementing the Internet protocols including routines for message handling, FTP download and/or Web server functionalities, said DSP architecture further including means for exchange of data on a network.

The invention also relates to a piece of communication equipment comprising a calculator, connection means to a telephone network and keyboarding and display means, wherein the connection means includes an integrated monolithic electronic component for connection to a telecommunications network and for exchanging data with at least a part of Internet protocols, wherein the component includes a DSP (Digital Signal Processor) type architecture.

The invention further relates to a process for adapting a piece of telecommunications equipment fitted with a DSP calculator controlling modem functions including loading a memory of said DSP calculator with a program including routines for the message-handling, FTP download and/or Web server functionalities.

### BRIEF DESCRIPTION OF THE DRAWINGS

The invention will be better understood from reading the description of a non-restrictive embodiment example which follows, with reference therein to the appended drawings in which

FIG. 1 shows a diagrammatic view of a first embodiment example; and

FIG. 2 shows a diagrammatic view of a second embodiment example.

### DETAILED DESCRIPTION

The invention concerns, in its most general sense, an integrated monolithic electronic component for connection to a telecommunications network and data exchange in accordance with a part at least of the Internet protocols. The component includes an architecture of the DSP (Digital Signal Processor) type. Preferably, the component according to the invention additionally includes an analogue/digital conversion component for connection with a telecommunications network.

This component performs the joint integration of an Internet protocol array and a modem program allowing data transmission on a physical medium (for example, the switched telephone network) in a single DSP (Digital Signal Processor). Implementing the Internet protocol array in one DSP and integrating this array with a modem program intended to provide data transmission (send and receive) on a given physical medium (the switched telephone network for example, or again other physical media such as Ethernet networks, carriers, and short-range radio connections) constitutes new technological characteristics, unusual for the person skilled in the art. Indeed, this type of processor is traditionally only used to run signal processing programs.

It is a question of simultaneously integrating in a same DSP an Internet protocol array and a signal processing program allowing data transmission on one of the physical media mentioned above.

This joint integration makes it possible to connect to the Internet by means of one of these media thanks to a single DSP (plus the component or components forming the material interface with the transmission medium under consideration, for example an analogue/digital conversion component to form the interface with a telephone line).

According to one particular variant, the invention includes at least one memory of at least about 8 kilo-words in which is loaded a program implementing the Internet protocols, and including routines for the message-handling, FTP download and/or Web server functionalities.

According to a preferred embodiment, the component according to the invention comprises a single buffer in each of the transmission directions for data preparation according to PPP, IP and TCP standards, and a buffer memory for intermediate calculations.

The invention also concerns a piece of communications equipment comprising a calculator, connection means to a telecommunications network, and keyboarding and display means, characterized in that the means of connection to the telecommunications network are constituted by an integrated monolithic electronic component for connection to a telecommunications network and for data exchange in accordance with a part at least of the Internet protocols, characterized in that the component includes an architecture of the DSP (Digital Signal Processor) type.

The invention further concerns a process for adapting a piece of telecommunications equipment fitted with a DSP calculator controlling modem functions, characterized in that in the memory of the DSP calculator is loaded with a program including the routines for the message-handling, FTP download and/or Web server functionalities.

The invention also concerns a process for processing digital data by a DSP processor with a view to transmission on the Internet network, characterized in that the TCP header, the IP header and the PPP header are calculated by storing the intermediate data in a single working memory and a single calculation buffer memory.

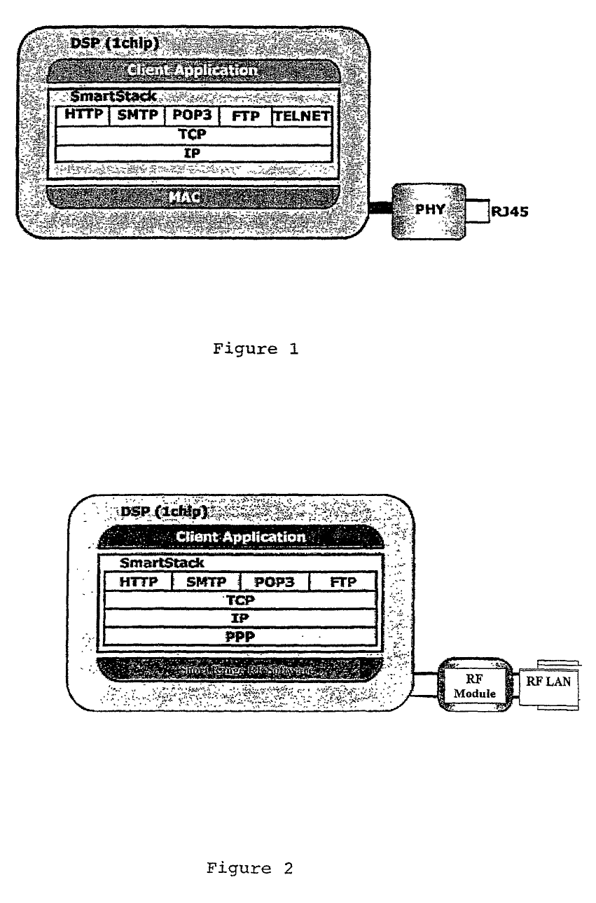

Referring now to the drawings, the component shown in FIG. 1 is a DSP component including modem functions wherein additionally a program is loaded to run condensed Internet protocols.

This is a component including an integrated processor to process the digital signal and to produce intermediate data and a group of shared random access memories (RAM) for storing intermediate digital data.

The modem program controls the connection to the physical network connecting the equipment to the Internet access point. The program for running the Internet protocols processes both the bottom layers (PPP, IP, TCP) and the top layers (HTTP, SMTP, POP, FTP) of all Internet protocols.

The program loaded in the DSP, therefore, contains several protocols among the following:

PPP,

IP,

TCP,

a part of HTTP, for controlling a simple Web server,

SMTP for sending e-mails,

POP3 for receiving messages,

FTP for downloading files,

Telnet.

The data is processed according to a particular algorithm avoiding the use of a plurality of working memories to allow these programs to run in the low capacity memories of the DSP.

A piece of equipment which can be connected to the Internet by a telephone line includes Internet protocol implementation means, signal processing means for the effective transmission of physical signals on the switched telephone network (modem), and a material interface with the telephone line.

In an implementation variant, represented by a diagrammatic view in FIG. 2, access to the Internet is not achieved directly by means of the switched telephone network, but through a local network (using, for example, the Ethernet, carrier transmission, or again a local radio connection) and a connection gateway between this local network and the switched telephone network.

A variant of the architecture, therefore, consists in implanting software modules allowing transmission on other physical media (such as the Ethernet or the carriers), and no longer only on the telephone line, in the same type of processor (DSP). This variant makes it possible to have interchangeable software modules in the DSP (or generally in an unspecified processor, allowing connectivity to the Internet by means of different physical media (and no longer only by a telephone line) while presenting a single interface with the associated equipment.

In a second variant, connection to the Internet (direct or through a local network) by the switched telephone network is replaced by a fast connection (using the ADSL or the cable for example). Here again, access can be made either directly, or through a local network.

Implementation of Internet Protocols:

Selected details of implementation allowing integration of the Internet protocol array in one DSP are as follows:

running the protocol array from an internal memory of the DSP,

using a single buffer in each transmission direction,

implementing message-handling, FTP download and Web server functionalities,

using a single working memory to generate different protocol headers.

Transmission Signals Processing Program:

The device allows a modem program to be run by the DSP to provide the physical transmission of the signals on a telephone line, or in the case of transmission on other physical media, for the DSP to run:

a program providing low-level Ethernet functions (usually provided by a Medium Access Control [MAC] component), where an Ethernet network is used,

a modulation/demodulation by carriers program, where carriers are used,

a baseband data processing program, where a short-range radio connection is used.

Material Interface with the Physical Medium:

In the case of a transmission on the switched telephone network, an analogue/digital conversion component is used to form the material interface with a telephone line. In the case of other media, the following are used:

an Ethernet network interface component, (aPHY[=physical]component), where an Ethernet network is used,

a power line interface circuit, where carriers are used,

a short-range radio transceiver circuit, where a short-range radio connection is used.

Gateway Function:

Some of the physical transmission layers mentioned above may be grouped in twos and implanted simultaneously in the same DSP, so as to achieve on a single processor a gateway function. Conceivable pairs are:

STN (switched telephone network/Ethernet,

STN/CC (carriers),

STN/SRR (short-range radio).

In addition to the Internet access protocols described above, the equipment including the gateway function comprises an implementation of at least one of the following protocols:

NAT (Network Address Translation), used to implant an IP address conversion function between the different addresses of the internal network equipment and the single IP address of this network seen from the Internet (router function),

DHCP (Dynamic Host Configuration Protocol, in the server), which allows an IP address to be assigned dynamically to each piece of internal network equipment.

Supervision Layer

The invention described above relates to the joint integration of an Internet protocol array and a modem program (or more generally a signal processing program allowing data transmission on a physical medium, as described above) in a single DSP processor. It is also possible to integrate, in the same DSP and above the protocol array, a third piece of software, called a “supervision layer” making it possible:

on the one hand, to convert data, exchanged by the DSP with the equipment in which it is integrated, into data contained within messages exchanged with a remote system through the Internet, and for this to happen in both transmission directions (send and receive),

on the other hand, to generate outgoing calls automatically to the Internet service provider for the purpose for example of sending an electronic message or verifying the possible receipt of an electronic message.

This call generation may for example arise from a local event (change of state of a DSP input, alarm, etc) or else be programmed to occur at a pre-set date and/or time.

Additionally the supervision layer may be responsible for guaranteeing that a datum has in fact been sent to a remote system, by using acquittal messages, and by generating callbacks to the Internet service provider, where necessary.

1. An electronic component for connection to a telecommunications network and data exchange in accordance with at least a part of Internet protocols comprising an integrated monolithic component constituted by a DSP (Digital Signal Processor) architecture including at least one memory in which is loaded a program implementing the Internet protocols including routines for message handling, FTP download and/or Web server functionalities, said DSP architecture further comprising means for exchange of data on a network.

2. The component according to claim 1, wherein the component includes means for exchanging data on a switched telephone network.

3. The component according to claim 1, wherein the component includes means for exchanging data on a local radio network.

4. The component according to claim 1, wherein the component includes means for exchanging data on an Ethernet network.

5. The component according to claim 1, wherein the component includes means for exchanging data on an electric network.

6. The component according to claim 1, further comprising an analogue/digital conversion component for connection with a telecommunications network.

7. The component according to claim 1, further comprising at least one memory of at least about 8 kilo-words in which is loaded a program implementing the Internet protocols, including routines for message-handling, FTP download and/or Web server functionalities.

8. The component according to any one of claims 2 to 7, further comprising a single buffer in each transmission direction for data preparation according to PPP, IP, and TCP standards, and a buffer memory for intermediate calculations.

9. The component according to claim 1, further comprising a protocol array and supervision layer software which:
converts data, exchanged in both transmission directions by the DSP with the equipment in which it is integrated, into data contained within messages exchanged with a remote system through the Internet, and generates outgoing calls automatically to an Internet service provider for sending an electronic message or verifying possible receipt of an electronic message.

10. The component according to claim 1, wherein the supervision layer confirms that a datum has been sent to a remote system, by using acquittal messages, and by generating callbacks to the Internet service provider, where necessary.

11. The component according to claim 1, further comprising means for an implementing of at least one of the following protocols:
NAT (Network Address Translation) to implant an IP address conversion function between different addresses of an internal network equipment and a single IP address of this network seen from the Internet (router function),
DHCP (Dynamic Host Configuration Protocol), which allows an IP address to be assigned dynamically to each piece of internal network equipment, and to perform a gateway function.

12. Communication equipment comprising a calculator, connection means to a telephone network and keyboarding and display means, wherein the connection means includes an integrated monolithic electronic component for connection to a telecommunications network and for exchanging data with at least a part of Internet protocols, wherein the component includes a DSP (Digital Signal Processor) type architecture.

13. A process for adapting a piece of telecommunications equipment fitted with a DSP calculator controlling modem functions comprising:
loading a memory of said DSP calculator with a program including routines for the message-handling, FTP download and/or Web server functionalities.

14. A process for processing digital data by a DSP processor according to claim 13, wherein a TCP header, an IP header and a PPP header are calculated by storing intermediate data in a single working memory and a single calculation buffer memory.
